(19) United States
(12) Patent Application Publication
(10) Pub. No.: US 2025/0088838 A1
(43) Pub. Date: Mar. 13, 2025

(54) ENHANCED MONITORING OF SUBSCRIBER DATA IN WIRELESS COMMUNICATION NETWORKS

(71) Applicant: T-MOBILE INNOVATIONS LLC, Overland Park, KS (US)

(72) Inventors: Anuj Sharma, Broadlands, VA (US); Anil Kumar Mariyani, Ashburn, VA (US); Deepesh Belwal, Ashburn, VA (US); Sriharsha Nagaraja Kadalbal, Sammamish, WA (US); Kumar Pushkar, Herndon, VA (US); Osama Mustafa, Maple Valley, WA (US); Henry Ha, Covington, WA (US); Kalpana Pinnaka, Renton, WA (US)

(21) Appl. No.: 18/462,945

(22) Filed: Sep. 7, 2023

(51) Int. Cl. H04W 8/20

(52) U.S. Cl. CPC H04W 8/20

(57) ABSTRACT

Technology, including systems, methods, and devices, is disclosed herein for operating a wireless network including a control plane element and data repository. A method of operating the wireless network includes the data repository storing subscriber datasets received from the control plane element. The wireless network monitors a capacity of the data repository and detects that the capacity of the repository is at a threshold value. The wireless network classifies a subscriber dataset for handling based on a parameter associated with the subscriber dataset. The handling includes deletion, compression, or preservation of the subscriber dataset. The wireless network performs the handling with respect to the subscriber dataset. In some implementations, the control plane device includes one of a Unified Data Manager, a Policy Charging Function, and Network Exposure Function and the data repository includes a Unified Data Repository.

### TECHNICAL FIELD

Aspects of the disclosure are related to the field of wireless communication networks and in particular to subscriber data management.

### BACKGROUND

Wireless communication networks face the challenge of addressing varying traffic loads while maintaining the Quality of Service (QoS) for their users. For example, a wireless network may be subject to periods of high utilization due to a concentration of users at a major public event or to rerouting of traffic in response to a site outage. During periods of high utilization, the increase in data traffic will tax the database memory, disk space, and CPU utilization of various network functions. Typically, traffic modeling is used to plan for the varying traffic loads, and the network control plane solutions for high utilization scenarios may include load balancing, dynamic resource allocation, routing optimization and so on.

The wireless network may be able to anticipate some high utilization scenarios, such as planned public events drawing large crowds, and take steps to improve readiness, for example, by rerouting data traffic to distribute the load across the network. However, during unanticipated traffic spikes, the network control plane may be designed to reactively drop network traffic to maintain network capacity and avoid a larger system failure. Dropping network traffic in reaction to diminished capacity can negatively impact the QoS of users whose usage is cut off as well as negatively impact network key performance indicators (KPIs). Moreover, in reacting to traffic spikes by indiscriminately dropping users, the network is not able to protect service to its higher-priority subscribers, such as business customers or wireless priority service (WPS) users.

### OVERVIEW

Technology, including systems, methods, and devices, is disclosed herein for operating a wireless network including a control plane element and data repository. A method of operating the wireless network includes the data repository storing subscriber datasets received from the control plane element. The method includes monitoring a capacity of the data repository and detecting that the capacity of the repository is at a threshold value. The method includes classifying a subscriber dataset for handling based on a parameter associated with the subscriber dataset. The handling includes deletion, compression, or preservation of the subscriber dataset. The method includes performing the handling with respect to the subscriber dataset. In some implementations, the control plane device includes one of a Unified Data Manager, a Policy Charging Function, and Network Exposure Function and the data repository includes a Unified Data Repository.

In some implementations, the subscriber dataset is classified for deletion based on a parameter comprising a timestamp of recency of activity associated with the subscriber dataset. In some implementations, the subscriber dataset is classified for compression based on a parameter comprising subscriber status associated with the subscriber dataset.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for managing capacity of a data repository of a wireless network in an implementation.

FIG. 2 illustrates a method of managing capacity of a data repository of a wireless network in an implementation.

FIGS. 3A and 3B illustrate exemplary workflows for managing capacity of a data repository of a wireless network a wireless network in an implementation.

FIG. 4 illustrates a systems architecture for a wireless network in an implementation.

FIG. 5 illustrates a systems architecture for a network data center of a wireless communication network in an implementation.

FIG. 6 illustrates a computing system suitable for implementing the various operational environments, architectures, processes, scenarios, and sequences discussed below with respect to the other Figures.

### DETAILED DESCRIPTION

Systems, methods, and devices are disclosed herein for controlling the utilization of network data repositories by monitoring capacity utilization and, in high utilization situations, prioritizing subscriber data for compression or deletion to ensure high-priority subscriber data is handled appropriately. In an implementation, in a subscription data repository, such as Unified Data Repository (UDR), of a wireless network, subscriber data is prioritized according to a number of criteria relating to a status of the subscriber with respect to the network, the recent usage of the network by the subscriber, and the type of transaction to which the subscriber data relates. When the storage capacity of the repository approaches or falls below a critical threshold (e.g., 10%), the UDR frees up storage space by implementing a prioritization scheme or logic which determines the subscriber datasets (i.e., data or records associated with a particular subscription or subscriber) to be deleted or compressed, thereby protecting high-priority subscriber datasets and maintaining the QoS for high-priority subscribers.

Data repositories of a 5G network such as a UDR store structured as well as unstructured data for other network functions. A UDR of a 5G network is a central repository for subscriber data for the Unified Data Management function (UDM) including subscriber profiles, plans, wireless services (e.g., voice, data, messaging), service activation/deactivation dates, authentication data, billing information, subscriber preferences and customizations relating to wireless services, usage history, roaming preferences, privacy information, and so on. The UDR also stores access and mobility data as well as session management information for subscriptions including information relating to voice calls, data sessions, and messaging activities, such as timestamps, data usage, network resources consumed, originating/terminating phone numbers, call duration, roaming data, and so on. The subscriber data stored by the UDR may be keyed to the Subscription Permanent Identifier (SUPI) of the subscriptions. With respect to other network functions of a 5G network, the UDR stores policy-related data accessible by Policy Charging Functions (PCFs) such as QoS settings, service plans, charging rules and other policy-related attributes. The UDR also interacts with Network Exposure Functions (NEFs) with respect to access to subscription information by third-party applications.

In an implementation, the prioritization hierarchy or logic for managing data storage of a subscription data repository includes multiple levels to prioritize the stored data based on characteristics of individual subscription datasets. The priority levels of the prioritization logic include rules by which to identify sets of data to be preserved in the data repository, to be compressed, or to be deleted. When the capacity of the repository approaches or falls below a threshold value, the rules are implemented to both preserve the higher priority data while freeing up space by selectively compressing or deleting other, less important data.

In an implementation, the prioritization logic includes six levels. The highest priority level of the logic relates to subscriptions that are authorized for Wireless Priority Service (WPS). The second highest priority level identifies subscriber data relating to access network mobility or provisioning transactions and prioritizes mobility data over provisioning data to ensure, for example, that existing calls are continued without dropping as a greater priority than establishing a new call. The third priority level prioritizes subscriber data according to QoS settings of the subscription or of the network slice of the device's access to the network. For example, the data repository may access a configuration table which identifies and prioritizes subscriptions according to characteristics such as device SKU, device type (e.g., mobile devices over IoT devices) device capability (e.g., 5G over LTE over 3G), subscription plan type (e.g., post-paid plans over prepaid plans, full service plans over more basic plans), device version (e.g., newly launched devices over older devices), and so on. The configuration table may also prioritize the subscriber data according to the type of use, such as voice data over video streaming or gaming. The configuration table identifies a sub-logic for prioritizing the subscription according to one or more QoS settings so that higher priority subscriber data is preserved (i.e., neither compressed nor deleted) over lower priority data.

Continuing the exemplary implementation, the fourth priority level identifies subscribers with no network activity for a predetermined period of time. For example, subscription plans with no network activity over the last 30 days may be tagged for compression. The fifth priority level identifies subscriptions according to the status of the plan so that the subscriber data of suspended and deactivated customers is prioritized for data compression.

The sixth priority level identifies stale session data on the data repository for deletion. In an implementation, the data repository tracks the most recent network activity of a subscription according to the timestamp of the most recent registration or of the most recent session data. When the capacity falls below the threshold for compression or deletion, the data repository identifies a set of session data as “stale” and ready for deletion. To identify the stale data, in an implementation, the repository may select a quantity (e.g., 10%) of the oldest session data to be deleted. To identify the oldest session data, the repository may order the session data, then select the oldest 10% of the session data from the order. In other implementations, the repository may select the oldest session data for deletion according to a window of time (e.g., all session data older than 30 days). The window of time may be predetermined, or it may be determined by computing how much of the session data falls in the window to ensure an appropriate amount is deleted (neither too much nor too little). The session data to be deleted includes data sent from the UDR to other network functions such as the Unified Data Manager (UDM), Policy and Charging Rules Function (PCRF), Home Subscriber Service (HSS), Telecommunications Application Server (TAS), and so on.

To implement a prioritization logic, the UDR may execute a prioritization model which prioritizes the stored data and identifies datasets for compression or deletion. In some implementations, the prioritization model may be an artificial intelligence (AI) or machine learning (ML) model which monitors the capacity utilization of the UDR, the rate of utilization, and other performance criteria and implements the prioritization logic to proactively address high utilization or potentially high utilization situations. For example, the AI model is trained on historical data relating to storage utilization, data storage allocation by type, and outcomes relating to storage performance after compression and deletion of selected data has been performed. The AI model may identify a quantity of data which must be freed up and balance the amount of data to be compressed with the amount of data to be deleted to free up sufficient storage space. For example, if the AI detects a rapid uptick in capacity consumption (e.g., in a high-utilization scenario), the AI model may forecast an amount of capacity which should be freed up to prevent an overload. Based on the forecasted amount and the prioritization logic, the AI model may identify a quantity of “stale” data to be safely deleted and other data which may be safely compressed to achieve the forecasted amount.

Implementations of the disclosed technology are applicable in a number of fields outside of wireless communication networks where transient high utilization of data storage can be a problem. For example, financial institutions generate substantial amounts of data due to transactional records, customer information, market data, and compliance requirements. Periodic activities like end-of-month processing, quarterly reporting, or high-frequency trading can result in temporary spikes in data storage utilization. Similarly, industries reliant on Internet of Things (IoT) devices and sensor networks, such as automated manufacturing, logistics, and agriculture, may experience transient spikes in data storage utilization during periods of high sensor activity or when processing large volumes of real-time data from connected devices. So, too, with media and entertainment industries, including video streaming services, online gaming platforms, and content production companies, may face periods of high utilization of data storage during, for example, livestreaming of sporting events, the release of highly anticipated movies or other TV shows, etc.

The technical benefit of the technology disclosed herein includes more granular control of data handling to ensure that network access and resource consumption by higher priority customers or traffic are safeguarded over those of lower priority customers or traffic, such as prioritizing business customers over residential customers, prioritizing access network mobility data to maintain active or existing calls over provisioning transactions for new calls, prioritizing active users over largely dormant devices, or prioritizing services according to network slice (e.g., voice calls over video streaming). By providing a more granular control in preserving data on network data repositories allows a wireless service provider to tailor its response according to parameters which reflect the importance of subscriptions or subscribers to the network rather than indiscriminately cutting off service across the board.

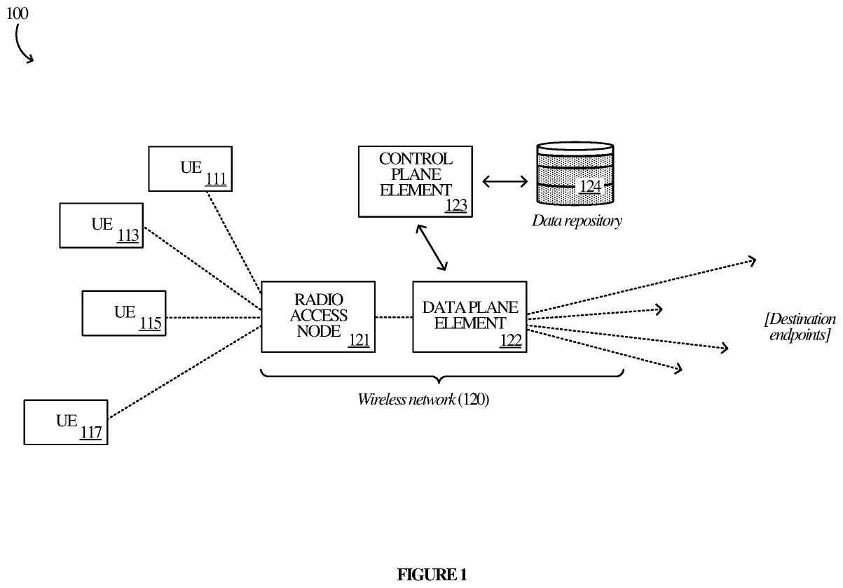

Turning now to the Figures, FIG. 1 illustrates operational environment 100 for managing capacity of a data storage repository of a wireless network in an implementation. Operational environment 100 includes user equipment (UEs) 111, 113, 115, and 117, wireless network 120, and destinations 140. Wireless network 120 includes radio access node (RAN) 121, data plane element 122, control plane element 123, and data repository 124 which stores network data including subscriber data. In operational environment 100, various ones of UEs 111-117 connect with various destinations (not shown) via wireless network 120.

User equipment (UEs) 111-117 are representative of smartphones, computers, sensors, controllers, and/or some other user apparatus with processing circuitry for wireless communication. UEs 111-117 exchange wireless communication signals with RAN 121 over radio frequency bands. RAN 121 is representative of equipment using radio frequencies to provide wireless connectivity to devices, such as Fifth Generation (5G) RANs, long-term evolution (LTE) RANs, gNodeBs, eNodeBs, NB-IoT access nodes, LP-WAN base stations, wireless relays, Wifi access nodes, Wifi hotspots, ENET access nodes, Bluetooth access nodes, and/or other wireless or wireline network transceivers.

UEs 111-117 and RAN 121 are representative of wireless communication devices or radios which wirelessly communicate using protocols such as Fifth Generation New Radio (5GNR), 5G Advanced, LTE, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). RAN 121 may also include other types of access nodes, such as a WLAN access nodes, and communication with home network 120 may be relayed through a Non-3GPP Inter-Working Function (N3IWF) network function (not shown) of the respective network.

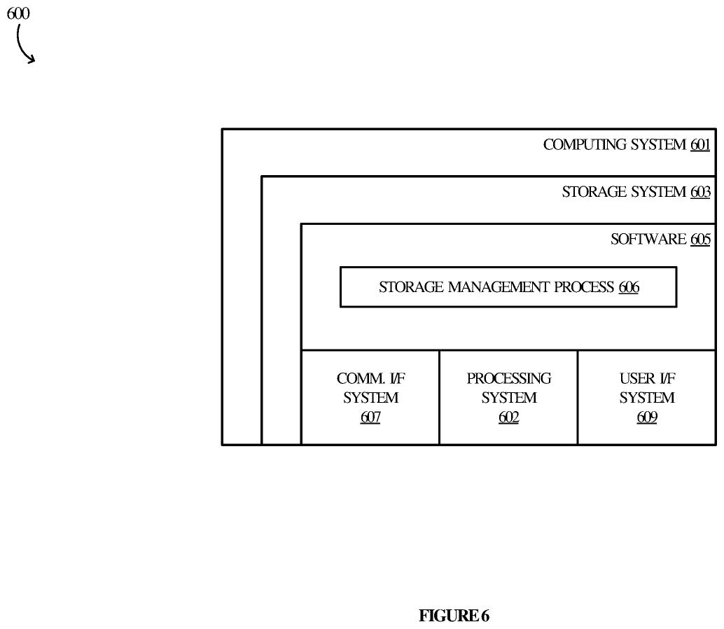

Wireless network 120 is representative of a network capable of using a Fifth Generation New Radio (5GNR) or LTE protocol to communicate with UEs 111-117 via a RAN, such as RAN 121. In an implementation, wireless network 120 is representative of a service-based architecture (SBA) which includes network functions which constitute the control plane and user plane of a wireless communication network core. The network functions are implemented on one or more suitable computing devices, of which computing device 601 of FIG. 6 is representative. Examples of suitable computing devices include server computers, blade servers, and the like. The network elements of wireless network 120 may be implemented in the context of one or more data centers, in a co-located or distributed manner, or in some other arrangement.

Data repository 124 is representative of a network function or element of wireless network 120 which stores data including subscriber data for retrieval and exposure by other network functions (not shown). Data repository 124 can include a Unified Data Repository (UDR), Unstructured Data Storage Function (UDSF), Home Subscriber System (HSS), or other data storage apparatus. Data repository 124 may be implemented on one or more suitable computing devices, of which computing device 601 of FIG. 6 is representative. Examples include server computers, blade servers, and the like.

Control plane element 123 is representative of a network function, such as a Unified Data Management (UDM), Access and Mobility Management Function (AMF), Session Management Function (SMF), Policy Control Function (PCF), or Network Exposure Function (NEF), which controls the exchange of the user data over RAN 121 and data network element 122 based on a subscriber profile of a UE. For example, control plane element 123 may use specific authentication mode and slice information for a UE based on the individual authentication mode and slice information in individual subscriber profile for that device.

Data plane element 122 of wireless network 120 is representative of a network function, such as a User Plane Function (UPF), Interworking Function (IWF), Gateway (GW), and/or other data transfer apparatus, which manages data traffic for a UE according to information from control plane element 123.

Destinations to which UEs 111-117 connect are endpoints of communication paths from UEs 111-117 through wireless network 120. Destinations can include endpoints in communication with any of UEs 111-117 for the transmission of IMS communication, such as a voice call, SMS, video call, or other IMS transmission. For example, a destination may be another user equipment or device. A destination may also be another wireless network or cloud service.

In operation, a UE, such as UE 115, sends a registration request to wireless network 120 for the purpose of establishing a communication path (e.g., for a voice call) to a destination. RAN 121 receives the request and relays the request to control plane element 123 via data plane element 122 to create a PDU session for UE 115. To create the PDU session for UE 115, control plane element 123 consults parameters within the request to determine a workflow for establishing the PDU session which includes policies received from other network functions of wireless network 120, such as data repository 124.

As access for UE 115 is registered and a PDU session is created, control plane element 123 exchanges information relating to UE 115 with data repository 124. If, however, data traffic on wireless network 120 is particularly heavy, the storage capacity of data repository 124 may become critically low, creating the risk that access to wireless network 120 will have to be cut off to avoid overloading the network, leading to dropping existing calls or new calls failing.

In an implementation of the technology disclosed herein, data repository 124 monitors its storage capacity and proactively manages the capacity to avoid a critically low storage situation. The storage capacity may be tracked in terms the capacity of data repository 124 or in terms of a rate at which the capacity of data repository 124 is being consumed. When the capacity or rate of capacity consumption approaches or reaches a critical threshold, data repository 124 implements a logic for prioritizing storage according to the type and quantity of data that is stored. Prioritizing storage can include deleting data identified as stale (e.g., far enough out of date such that preservation of the data is a very low priority) and compressing data to free up capacity. Prioritizing can also include prioritizing data for storage, such as prioritizing mobility data of an existing call over provisioning data for a new call. By deleting and/or compressing data stored by data repository 124, an overload situation may be avoided and service to various subscribers can be safeguarded in a manner consistent with the relative priority of the subscribers to the network.

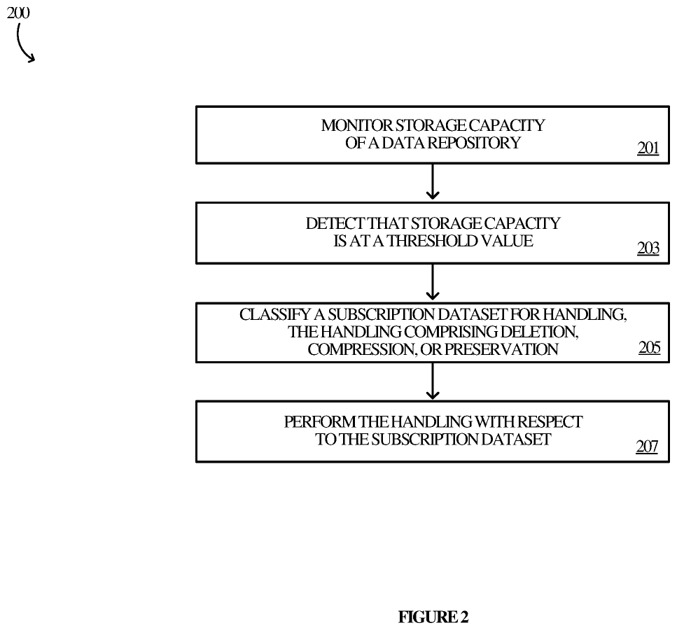

FIG. 2 illustrates process 200 for monitoring the storage capacity of a network storage device in an implementation. Process 200 may be implemented on one or more computing devices, such as server computers or computers in the context of a network data center, according to program instructions which direct the computing devices to function as follows, referring parenthetically to the steps in FIG. 2 and in the singular for the sake of clarity.

A computing of a wireless network monitors the storage capacity of a network data repository (step 201). In an implementation, a network storage device or data repository, such as a UDR, accumulates subscriber datasets including session data, mobility data, and subscriber profile data, from various control plane devices, such as UDMs, PCRFs, HSSs, TASs, and so on. During normal usage, the computing device monitors the available storage capacity of the data repository as data is written to the repository. The computing device may also monitor the rate at which storage is being consumed. In some implementations, monitoring storage capacity includes comparing the available capacity with anticipated storage needs. For example, when an uptick in data traffic is expected, the capacity of the storage device may be monitored with respect to an estimated capacity which would be necessary to prevent the storage device from being completely filled and unable to receive new data. In some implementations, a network control plane element in communication with the repository monitors the storage capacity of the repository and performs the other steps of process 200, or the repository itself monitors its storage capacity and performs the other steps of process 200.

The computing device detects that the storage capacity of the data repository is below a critical threshold (step 203). In an implementation, the computing device implements a prioritization logic for managing the storage capacity of the data repository, the logic including a hierarchy of operations to be performed to manage the storage capacity as the capacity nears or reaches a threshold capacity or in anticipation of heavy data traffic. The prioritization logic includes operations for deleting, compressing, and safeguarding data or datasets according to priorities of the network with respect to subscription criteria so that the repository does not become fully consumed.

As capacity of the storage device is consumed, it may reach a critical threshold, such as 5% or 10% of the device capacity, meaning that only 5% or 10% of the repository is available for receiving and storing incoming data. In some implementations, the available capacity is compared with the rate that capacity is being consumed to determine that the repository will be full or nearly full without measures being taken to prevent completely filling the repository.

In some implementations, the threshold is a value which reflects how full the repository is rather than how much capacity is still available. For example, if the threshold is set to 95%, when the computing device detects that the stored data has reached or is approaching 95% of the repository capacity, this may trigger an implementation of the prioritization logic for managing capacity to prevent completely filling the repository.

The computing device classifies subscriber datasets for handling, such as deletion, compression, or preservation, based on a parameter associated with the dataset (step 205). In an implementation, the prioritization logic assigns a priority for handling a subscriber dataset based on parameters such as the type of subscriber data (e.g., session data, transaction data, mobility data), a timestamp of the most recent activity (e.g., the last time the user device registered with the network), subscription status (e.g., whether the subscription or user account is suspended or deactivated), QoS parameters, and WPS status. Based on the prioritization logic applied according to the parameters of the data, the subscriber dataset is selected for deletion, compression, or preservation. With the subscriber dataset classified for handling, the computing device performs the handling—deleting, compressing, or preserving the dataset according to the prioritization logic (step 207).

In an implementation, the computing device identifies session data as eligible for deletion based on how old the data is. For example, the computing device may apply a rule which specifies that for user devices whose most recent interaction with the network is more than 30 days old, the session data for those devices is to be deleted. In identifying the datasets to be deleted, the computing device may calculate the quantity of data to be deleted and the amount of storage capacity that will be freed up after the deletion. The timestamp used to identify data eligible for deletion may relate to the last registered network attachment or other activity.

In some implementations, to identify datasets eligible for deletion, the computing device may apply a rule which specifies a percentage of the session data to be deleted of the stored session data and correlate the percentage to a recency of the (timestamp of the) session data. For example, the rule may specify that the oldest 10% of the session data is to be deleted to free up storage capacity. In still other implementations, the computing device may apply a rule which specifies the recency of the activity based on how much data would be deleted and how much capacity is to be regained. So, for example, the computing device may apply an algorithm to determine that deleting the oldest 12% of the session data or the session data older than 38 days will free up sufficient capacity to avoid filling the repository completely.

In some implementations, the steps of process 200 may be implemented by an AI engine to manage the capacity of data repository. For example, the AI engine may be trained using historical capacity data, network usage data, and capacity overage or saturation event data to identify scenarios when the data repository is at risk of being completely consumed. The AI engine may also identify the parameters by which data is to be identified and deleted, such as specifying session data according to the recency of the activity or according to a percentage of the oldest session data, to ensure the repository has sufficient capacity to continue operating.

Referring again to FIG. 1, operational environment 100 illustrates a brief example of process 200 as employed by elements of operational environment 100. In operation, as UEs such as UEs 111-117 access wireless network 120, data repository 124 accumulates subscriber data associated with the devices. Data repository 124 monitors its storage capacity with respect to a threshold value which, when reached, causes data repository 124 to enact measures to increase the amount of available storage.

When data repository 124 detects that the storage usage has reached or exceeded a critical usage threshold (e.g., 95%), data repository 124 selects stored data for deletion or compression according to a prioritization of the data. To implement the prioritization, data repository 124 classifies the stored data according to criteria which relate to the importance of the data, device, or subscriber with respect to wireless network 120. For example, if UE 115 is a WPS-authorized subscriber making a WPS call, continuing the service of UE 115 will take priority over other, non-WPS subscribers. Thus, subscriber data for UE 115 will be categorized for the highest level of preservation.

In an implementation, data repository 124 applies a first level of handling with respect to session data stored by data repository 124. Data repository 124 identifies session data which is eligible for deletion according to the most recent timestamp of network activity. For example, the session data may be identified for deletion according to an expiry date (e.g., session data older than 30 days). The session data identified for deletion is then deleted from data repository 124.

When the session data is deleted, freeing up some memory and storage capacity, data repository 124 may recompute its storage usage. If the storage usage still exceeds the critical threshold, data repository 124 may identify subscriber data which is eligible for compression to free up additional storage capacity. For example, data repository 124 may identify subscriber data associated with subscriptions or accounts which are suspended or deactivated with respect to wireless network 120. The subscriber data identified for compression is then compressed on data repository 124.

The process of classifying subscriber data for handling continues until the usage capacity is at or below the critical threshold. For example, if the critical usage threshold is 95%, the data handling according to the prioritization logic may continue until storage usage is at or below 95% or at/below a second, lower threshold, e.g., 90%. Continuing the data handling, data repository 124 may identify additional subscriber data for compression according to the recency of activity of the subscriber data. For example, subscriber data for which there is no network activity within a predetermined timeframe (e.g., 30 days) may be identified for compression.

The process of classifying subscriber data for handling includes identifying data for preservation, i.e., data which is not to be compressed or deleted. Data compression may be applied to subscriber data starting with the lowest priority data identified for preservation up to the highest priority data identified for preservation. For example, subscriber data for WPS users or devices may be classified as the highest priority data, meaning it would be the last type of subscriber data to be compressed. Following WPS subscriber data, non-WPS subscriber data may be classified for preservation according to transaction type. For example, for non-WPS subscriptions, mobility data associated with continuing an ongoing call may be classified as a higher priority for preservation than data for provisioning transactions of new calls.

Beyond classifications based on transaction type, subscriber data may be classified according to QoS parameters. In an implementation, data repository 124 may access a configuration table to prioritize service or subscriber data according QoS settings such as subscription type (post-paid versus prepaid), device type (newly launched devices over older types), type of use (5G over LTE, voice data over streaming or gaming), bandwidth consumption, speed, stability, as well as other factors.

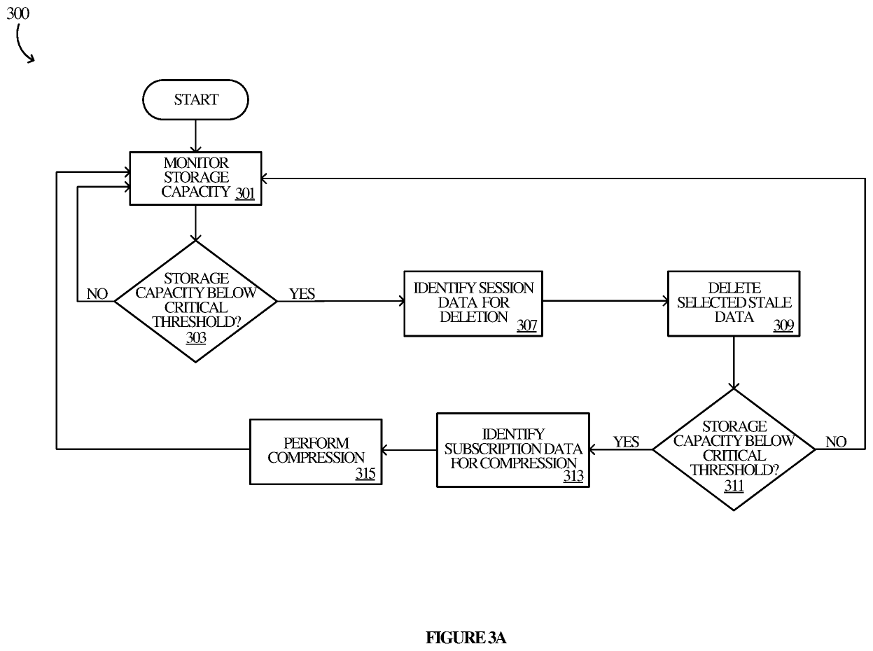

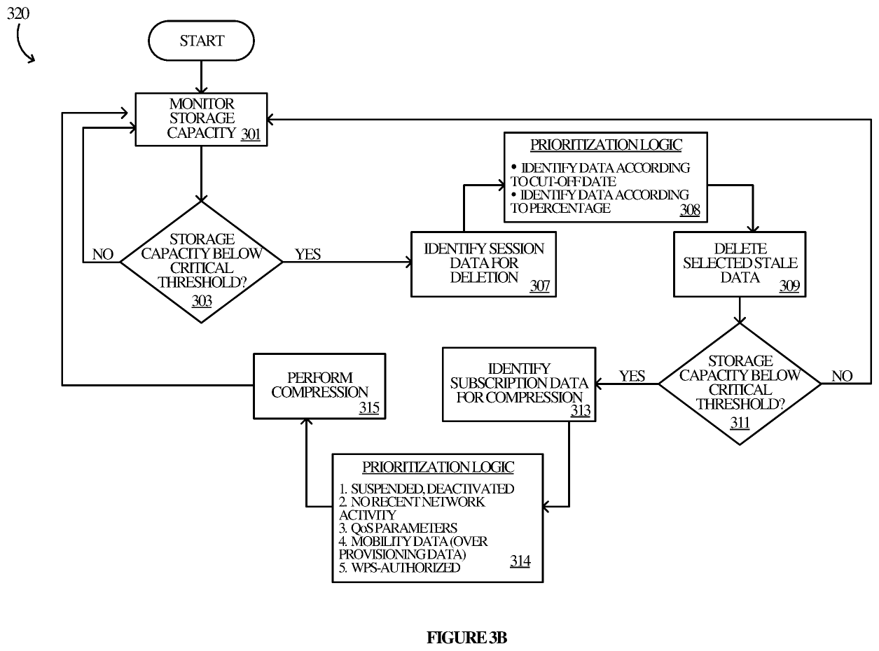

Turning now to FIGS. 3A and 3B illustrate workflows 300 and 320, respectively, which are executed by a computing device to manage the storage capacity of a data repository, such as a UDR, of a wireless network.

Starting with step 301 of workflow 300, the available capacity or storage usage of a data repository such as a UDR is continually monitored by the device itself or by another network function. As the available capacity is monitored, if UDR or other device detects that the available capacity of the UDR has fallen below a predetermined threshold value (e.g., 8% of the overall capacity) (step 303), “stale” session data is identified for deletion (step 307). In various implementations, a quantity of session data is identified based on the age of the data such that older data will be deleted before newer data. To select which session data is to be deleted, the UDR or other monitoring device may identify a quantity which is to be deleted and select that quantity of the oldest session data for deletion. Alternatively, the UDR or other monitoring device may identify an expiry or cut-off date such that session data with timestamps earlier than the expiry date are eligible for or selected for deletion.

When the selected session data is deleted (step 309), the UDR or other monitoring device reevaluates the available capacity or storage usage of the UDR relative to the threshold value. If the available capacity is still below the threshold value (step 311), additional data from the UDR is selected for compression (step 313). In various implementations, subscriber data onboard the UDR is selected for compression based on the type of data, age of data, and other criteria. When the selected data is compressed (step 315), the UDR or monitoring device continues the background monitoring of the available capacity.

Workflow 320 illustrates a process for proactively managing the available capacity of a network storage device, such as a UDR, to prevent an overload of the device in an implementation similar to workflow 300. In workflow 320, when the available capacity is below the threshold value and session data is identified for deletion (step 307), the UDR or other monitoring device implements a prioritization logic (step 308) to identify which of the session data is to be deleted. In some implementations, the session data with timestamps earlier than the cut-off date are selected for deletion. In other implementations, the to-be-deleted session data is identified according to quantity such that the quantity includes the oldest session data.

Continuing with workflow 320, subsequent to deleting the selected session data, if the available capacity is still below the threshold value, additional data is identified for compression (step 313). In various implementations, to identify subscriber data for compression, the UDR or other monitoring device implements a prioritization logic (step 314) which prioritizes the data for compression. For example, subscriber data associated with suspended or deactivated accounts is the first to be compressed, followed by subscriber data for subscriptions with no recent network activity, then by QoS parameters, and so on. To implement the compression, the UDR or monitoring device may identify a quantity of storage capacity that must be freed up to achieve a desired level of available capacity. The subscriber data is selected according to the prioritization logic until the identified quantity for compression is reached.

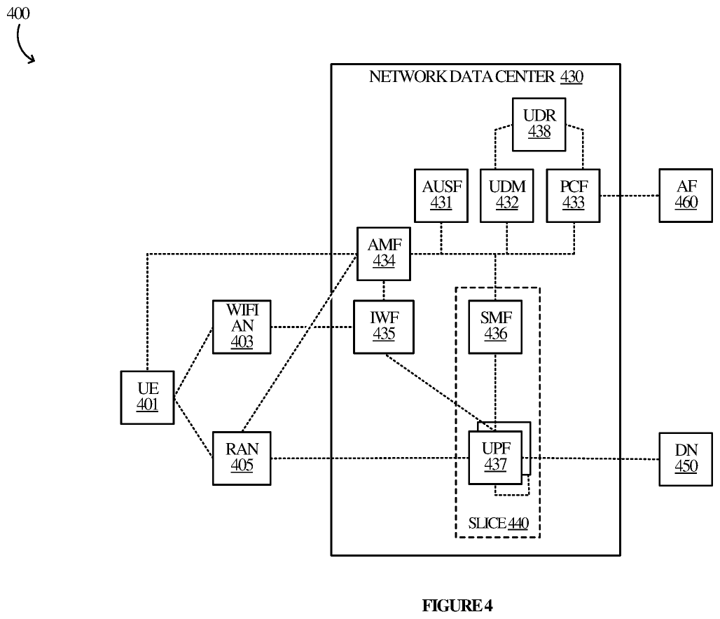

FIG. 4 illustrates wireless communication system 400 that serves wireless User Equipment (UE) 401 in an implementation. Wireless communication system 400 includes UE 401, Wifi Access Node (AN) 403, 5GNR RAN 405, Interworking Function (IWF) 435, Access and Mobility Management Function (AMF) 434, Authentication Server Function (AUSF) 431, Unified Data Management (UDM) 432, Policy Control Function (PCF) 433, Unified Data Repository (UDR) 438, Session Management Function (SMF) 436, User Plane Function (UPF) 437, and Application Function (AF) 460. UDR 438 is representative of computing devices with capabilities for network data storage, of which computing device 601 of FIG. 6 is representative. In various implementations, UDR 438 performs data management and handling operations according to the technology disclosed herein, such as process 200 of FIG. 2. AF 460 may provide policies applicable to control plane functions, that is, to the application, presentation, and/or session layers of the OSI protocol stack. IWF 435 includes non-3GPP IWFs (N3IWFs) for providing untrusted non-3GPP access to network data center 430, such as access via a non-cellular access network. Wireless network slice 440 includes UPF 437 and SMF 436. DN 450 is representative of a data network, Internet access, third-party resource, or other endpoint of an end-to-end communication path from UE 401.

In an implementation, as UEs such as UE 401 access network data center 430, network functions such as UDM 432 and PCF 433 communicate with UDR 438 to store and receive various types of network data for UEs. For example, in operation, UDM 432 accesses subscriber data (e.g., subscriber profiles) from UDR 438. Network data stored by UDR 438 includes subscriber profiles including identities, subscription details, service preferences, authentication credentials, and billing information. Subscriber data stored by UDR 438 may also include records for voice calls, data sessions, and messaging activities which such information as originating and terminating phone numbers, call duration, timestamps, data usage, and network resources consumed. Subscriber data stored by UDR 438 can also include location data such as geographic coordinates, cell tower information, and GPS data. Subscriber data stored by UDR 438 can also include subscription or service plan, service features, QoS parameters, and service policies as well as roaming data such as roaming agreements, authentication information, visited network details, and billing records. UDR 438 may also store subscriber data including security and fraud data such as authentication logs. In addition to subscriber data, UDR 438 also stores policy data such as network rules, access rules, mobility rules, charging rules, and so on.

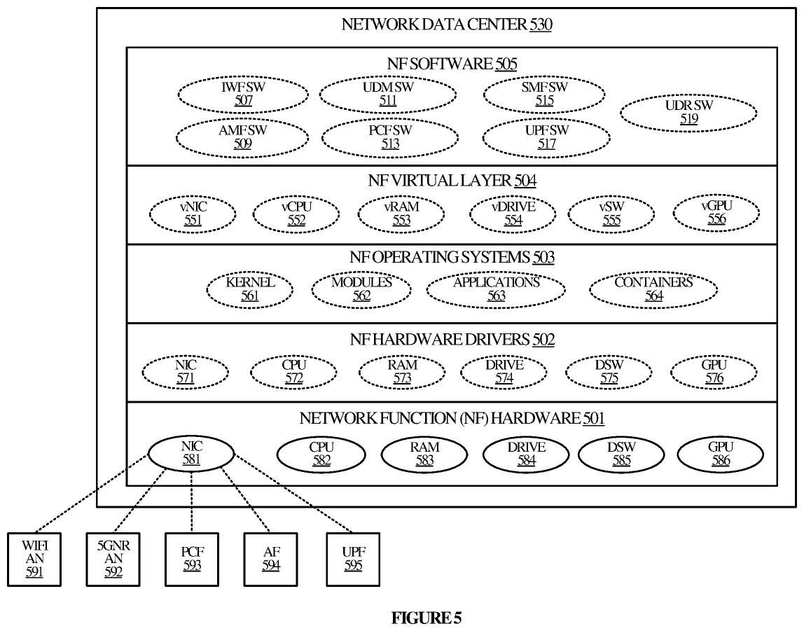

FIG. 5 illustrates exemplary network data center 530, a network core of a wireless communication system of which wireless network 120 of FIG. 1 is representative. Network data center 530 includes network function (NF) software 505, network function virtual layer 504, network function operating systems 503, network function hardware drivers 502, and network function hardware 501.

Network function software 505 of network data center 530 includes software for executing various network functions: IWF software 507, AMF software 509, UDM software 511, PCF software 513, SMF software 515, UPF software 517, and UDR software 519. Other network function software, such as network repository function (NRF) software, are typically present but are omitted for clarity. In various implementations, UDR software 519 performs data management processes described herein, such as process 200 of FIG. 2, on one or more computing devices of which computing device 601 of FIG. 6 is representative.

Network function virtual layer 504 includes virtualized components of network data center 530, such as virtual NIC 551, virtual CPU 552, virtual RAM 553, virtual drive 554, virtual software 555, and virtual GPU 556. Network operating systems 503 includes components for operating network data center 530, including kernels 561, modules 562, applications 563, and containers 564 for network function software execution. Network function hardware drivers 502 include software for operating network function hardware 501 of network data center 530, including network interface card (NIC) drivers 571 for network interface cards (NICs) 581, CPU drivers 572 for CPUs 582, RAM drivers 573 for RAM 583, flash/disk drive drivers 574 for flash/disk drives 584, data switch (DSW) drivers 575 for data switches 585, and drivers 576 for GPUs 586. Network interface cards 581 of network function hardware 501 include hardware components for communicating with Wifi access node 591, 5GNR access node 592, PCF 593, application server 594, and UPF 595.

Turning now to FIG. 6, architecture 600 illustrates computing device 601 that is representative of any system or collection of systems in which the various processes, programs, services, and scenarios disclosed herein may be implemented. Examples of computing device 601 include, but are not limited to, server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements storage management process 606, which is representative of the storage management processes discussed with respect to the preceding Figures, such as process 200. When executed by processing system 602, software 605 directs processing system 602 to operate as described herein for at least the various processes, operational scenarios, and sequences discussed in the foregoing implementations. Computing device 601 may optionally include additional devices, features, or functions not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, which are capable of communicating with processing system 602 or possibly other systems.

Software 605 (including storage management process 606) may be implemented in program instructions and among other functions may, when executed by processing system 602, direct processing system 602 to operate as described with respect to the various operational scenarios, sequences, and processes illustrated herein. For example, software 605 may include program instructions for implementing the storage management processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support storage management operations. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary, etc.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless network, the wireless network comprising:
a control plane element; and
a data repository;
the method comprising:
storing, by the data repository, subscriber datasets received from the control plane element;
monitoring, by the data repository, a capacity of the data repository;
detecting, by the data repository, that the capacity of the data repository is at a threshold value;
classifying, by the data repository, a subscriber dataset of the subscriber datasets for handling based on a parameter associated with the subscriber dataset, wherein the handling comprises one of deletion, compression, or preservation of the subscriber dataset; and
performing, by the data repository, the handling with respect to the subscriber dataset.

2. The method of claim 1, wherein the handling comprises deletion based on the parameter comprising a timestamp of recency of activity.

3. The method of claim 2, wherein the handling comprises compression based on the parameter comprising a subscription status associated with the subscriber dataset, wherein the subscription status is one of suspended and deactivated with respect to the wireless network.

4. The method of claim 3, wherein the handling comprises compression based on the parameter comprising a recency of activity associated with the subscriber dataset.

5. The method of claim 4, wherein the handling comprises compression based on one or more Quality of Service parameters associated with the subscriber dataset.

6. The method of claim 5, wherein the handling comprises preservation based on the parameter comprising a type of transaction data associated with the subscriber dataset.

7. The method of claim 6, wherein the handling comprises preservation based on the parameter comprising a Wireless Priority Service status associated with the subscriber dataset.

8. The method of claim 2, wherein classifying the subscriber dataset for deletion comprises identifying session data older than a specified time for deletion.

9. The method of claim 2, wherein the control plane element comprises one of: a Unified Data Manager, a Policy Charging Function, and a Network Exposure Function, and wherein the data repository comprises a Unified Data Repository.

10. A method of operating a data repository of a wireless network, comprising:
monitoring a capacity of the data repository, wherein the data repository stores subscriber dataset;
detecting that the capacity of the data repository is at a threshold value;
classifying a subscriber dataset of the subscriber datasets for handling based on a parameter associated with the subscriber dataset, wherein the handling comprises one of deletion, compression, or preservation of the subscriber dataset; and
performing the handling with respect to the subscriber dataset.

11. The method of claim 10, wherein the handling comprises deletion based on the parameter comprising a timestamp of a recency of activity associated with the subscriber dataset.

12. The method of claim 11, wherein the handling comprises compression based on the parameter comprising a subscription status associated with the subscriber dataset, wherein the subscription status is one of suspended and deactivated with respect to the wireless network.

13. The method of claim 12, wherein the handling comprises compression based on the parameter comprising a recency of activity associated with the subscriber dataset.

14. The method of claim 13, wherein the handling comprises compression based on one or more Quality of Service parameters associated with the subscriber dataset.

15. The method of claim 14, wherein the handling comprises preservation based on the parameter comprising a type of transaction data associated with the subscriber dataset.

16. The method of claim 15, wherein the handling comprises preservation based on the parameter comprising a Wireless Priority Service status associated with the subscriber dataset.

17. A data repository of a wireless network comprising:
one or more computer-readable storage media;
one or more processors operatively coupled with the one or more computer-readable storage media; and
program instructions stored on the one or more computer-readable storage media that, when executed by the one or more processors, direct the data repository to:
monitor a capacity of the data repository, wherein the data repository stores subscriber datasets;
detect that the capacity of the data repository is at a threshold value;
classify a subscriber dataset of the subscriber datasets for handling based on a parameter associated with the subscriber dataset, wherein the handling comprises one of deletion, compression, or preservation of the subscriber dataset; and
perform the handling with respect to the subscriber dataset.

18. The data repository of claim 17, wherein the handling comprises deletion based on the parameter comprising a timestamp of a recency of activity associated with the subscriber dataset.

19. The data repository of claim 18, wherein the handling comprises compression based on the parameter comprising a subscription status associated with the subscriber dataset, wherein the subscription status is one of suspended and deactivated with respect to the wireless network.

20. The data repository of claim 19, wherein the handling comprises compression based on the parameter comprising recency of activity associated with the subscriber dataset.
